(19) United States
(12) Patent Application Publication
(10) Pub. No.: US 2025/0313195 A1
(43) Pub. Date: Oct. 9, 2025

(54) VEHICLE CONTROL APPARATUS AND METHOD THEREOF

(71) Applicants: Hyundai Motor Company, Seoul (KR); Kia Corporation, Seoul (KR)

(72) Inventors: Bo Young Yun, Hwaseong-Si (KR); Su Min Jo, Hwaseong-Si (KR); In Sun Lee, Hwaseong-Si (KR)

(21) Appl. No.: 18/934,411

(22) Filed: Nov. 1, 2024

(30) Foreign Application Priority Data
Apr. 3, 2024 (KR) 10-2024-0045437

(51) Int. Cl. B60W 30/09; G06V 10/764

(52) U.S. Cl. CPC B60W 30/09; G06V 10/764; B60W 2420/403; B60W 2420/408

(57) ABSTRACT

A vehicle control apparatus includes light detection and ranging device (LiDAR), a camera, a radar, a memory, and one or more processors. The vehicle control apparatus may obtain a plurality of dynamic fusion tracks in a specific frame, which correspond to a plurality of external objects, and delete a target dynamic fusion track corresponding to a target object among the plurality of external objects in the specific frame, based on the target dynamic fusion track being obtained via only the LiDAR. The target dynamic fusion trac may be deleted further based on at least one of: whether an error has occurred in the radar and the camera in the specific frame, an object type, a camera track, or a radar track. The vehicle control apparatus may further control a vehicle, based on at least one remaining dynamic fusion track of the plurality of dynamic fusion tracks in the specific frame.

### CROSS-REFERENCE TO RELATED APPLICATION

This application claims the benefit of priority to Korean Patent Application No. 10-2024-0045437, filed in the Korean Intellectual Property Office on Apr. 3, 2024, the entire contents of which are incorporated herein by reference.

### TECHNICAL FIELD

The present disclosure relates to a vehicle control apparatus and a method thereof, and more particularly, relates to technologies for identifying an object by means of a plurality of sensors.

### BACKGROUND

The race to develop an autonomous vehicle technology or a driving assistance technology of a vehicle has intensified in recent years. Responding to unexpected situations without the manipulation of a driver and adjusting a driving path may require a vehicle to explore external objects around it and establish a control strategy for the external objects.

The vehicle may obtain data indicating a position of an external object by means of a plurality of sensors, such as light detection and ranging device (LiDAR), radio detection and ranging (radar), and a camera. A study for increasing the accuracy of information about an external object, for example, obtaining a position of the external object, based on pieces of information obtained from the plurality of sensors and classifying a type of the external object, has been conducted.

### SUMMARY

The present disclosure has been made to solve the above-mentioned problems found in some implementations while advantages achieved by those implementations are maintained intact.

An aspect of the present disclosure provides a vehicle control apparatus for increasing the accuracy of identifying an object capable of being in a movement state and a method thereof.

Another aspect of the present disclosure provides a vehicle control apparatus for identifying an object by means of sensors and a method thereof.

Another aspect of the present disclosure provides a vehicle control apparatus for decreasing misrecognition or miscontrol, due to the classification performance of LiDAR, and a method thereof.

Another aspect of the present disclosure provides a vehicle control apparatus for decreasing misrecognition or miscontrol, due to the object classification performance of radar, and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: a light detection and ranging device (LiDAR); a camera; a radar; one or more processors; and memory. The memory may store instructions that, when executed by the one or more processors, cause the vehicle control apparatus to: obtain, via at least one of the LiDAR, the camera, or the radar, a plurality of dynamic fusion tracks in a specific frame, the plurality of dynamic fusion tracks corresponding to a plurality of external objects classified into objects capable of being in a movement state; delete, among the plurality of dynamic fusion tracks, a target dynamic fusion track corresponding to a target object among the plurality of external objects in the specific frame, based on the target dynamic fusion track being obtained via only the LiDAR among the LiDAR, the camera, and the radar, and further based on at least one of: whether an error has occurred in the radar and the camera in the specific frame, an object type of the target dynamic fusion track, a camera track, in a previous frame, obtained via the camera within a specified time before the specific frame, or a radar track, in the previous frame, obtained via the radar; and control a vehicle, based on at least one remaining dynamic fusion track of the plurality of dynamic fusion tracks in the specific frame after the deletion of the target dynamic fusion track.

The instructions, when executed by the one or more processors, may cause the vehicle control apparatus to delete the target dynamic fusion track by: deleting the target dynamic fusion track, based on the target dynamic fusion track being obtained via the LiDAR only, based on only a LiDAR track in the specific frame, and based on at least one of: the error not having occurred in the radar and the camera in the specific frame, the object type of the target dynamic fusion track being an automobile, the object type of the target dynamic fusion track being an unknown type, the target dynamic fusion track obtained in the previous frame being not obtained via the radar track in the previous frame, or the target dynamic fusion track in the previous frame being not obtained via the camera track in the previous frame.

The instructions, when executed by the one or more processors, may further cause the vehicle control apparatus to: obtain a fusion track in the specific frame, based on at least one of the camera track in the specific frame, or the radar track in the specific frame; and obtain the target dynamic fusion track, based on at least one of a LiDAR track in the specific frame or the fusion track.

The instructions, when executed by the one or more processors, may cause the vehicle control apparatus to delete the target dynamic fusion track by: deleting the target dynamic fusion track, based on the target dynamic fusion track being obtained only via the radar track in the specific time, and based on at least one of: a position of the target dynamic fusion track being included in a specified area with respect to the vehicle, the target dynamic fusion track being obtained based on only the fusion track obtained in the specific frame, the target dynamic fusion track in the previous frame, corresponding to the target dynamic fusion track, being obtained via the LiDAR and corresponding to the target object, or a second dynamic fusion track different from the target dynamic fusion track being obtained via the LiDAR track in the specific frame.

The instructions, when executed by the one or more processors, may cause the vehicle control apparatus to delete the target dynamic fusion track by: deleting the target dynamic fusion track, based on the target dynamic fusion track being obtained only via the radar track in the specific frame, and based on at least one of: a position of the target dynamic fusion track being included in a specified area with respect to the vehicle, the target dynamic fusion track being obtained based on only the fusion track obtained in the specific frame, the fusion track in the previous frame being obtained via the camera track, a second fusion track different from the fusion track in the specific frame being obtained via the camera track, a third fusion track different from the fusion track being obtained via the camera track in the specific frame, or a second dynamic fusion track different from the target dynamic fusion track being obtained via the camera track in the specific frame.

The instructions, when executed by the one or more processors, may further cause the vehicle control apparatus to: determine, in a lane in which the vehicle is located, a point, at which a difference between a longitudinal position of the vehicle and a longitudinal position of the point is less than a specified distance, to be included in the specified area.

The instructions, when executed by the one or more processors, may further cause the vehicle control apparatus to: classify the target object corresponding to the deleted target dynamic fusion track as an object incapable of being in the movement state.

Each of the plurality of dynamic fusion tracks correspond to at least one of a pedestrian, an automobile, a two-wheeled vehicle, or a bicycle.

The vehicle control apparatus may further include: a near vehicle detector (NVD) camera, different t from the camera, configured to capture one of a front of the vehicle or a rear of the vehicle; and a rear side view (RSIR) camera, different from the camera, configured to capture a rear corner of the vehicle. The instructions, when executed by the one or more processors, may further cause the vehicle control apparatus to obtain the plurality of dynamic fusion tracks by: obtaining the plurality of dynamic fusion tracks via at least one of the LiDAR, the camera, the radar, the NVD camera, or the RSIR camera.

The instructions, when executed by the one or more processors, may further cause the vehicle control apparatus to delete the target dynamic fusion track by: deleting the target dynamic fusion track based on the error not having occurred in the radar, the camera, the NVD camera, and the RSIR camera.

The instructions, when executed by the one or more processors, may cause the vehicle control apparatus to obtain the plurality of dynamic fusion tracks by: obtaining, via the NVD camera, an NVD track corresponding to the target object; obtaining, via the RSIR camera, an RSIR track corresponding to the target object; obtaining a fusion track, based on at least one of: the camera track, in the specific frame, obtained via the camera, the radar track, in the specific frame, obtained via the radar, the NVD track in the specific frame, or the RSIR track in the specific frame; and obtaining the plurality of dynamic fusion tracks based on at least one of the fusion track or a LiDAR track in the specific frame.

According to one or more example embodiments of the present disclosure, a vehicle control method, performed by one or more processors, may include: obtaining, via at least one of a light detection and ranging device (LiDAR), a camera, or a radar, a plurality of dynamic fusion tracks in a specific frame, the plurality of dynamic fusion tracks corresponding to a plurality of external objects classified into objects capable of being in a movement state; deleting, among the plurality of dynamic fusion tracks, a target dynamic fusion track corresponding to a target object among the plurality of external objects in the specific frame, based on the target dynamic fusion track being obtained via only the LiDAR among the LiDAR, the camera, and the radar, and further based on at least one of: whether an error has occurred in the radar and the camera in the specific frame, an object type of the target dynamic fusion track, a camera track, in a previous frame, obtained via the camera within a specified time before the specific frame, or a radar track, in the previous frame, obtained via the radar; and controlling a vehicle, based on at least one remaining dynamic fusion track of the plurality of dynamic fusion tracks in the specific frame after the deletion of the target dynamic fusion track.

Deleting the target dynamic fusion track may include: deleting the target dynamic fusion track, based on the target dynamic fusion track being obtained via the LiDAR only, based on only a LiDAR track in the specific frame, and based on at least one of: the error not having occurred in the radar and the camera in the specific frame, the object type of the target dynamic fusion track being an automobile, the object type of the target dynamic fusion track being an unknown type, the target dynamic fusion track obtained in the previous frame being not obtained via the radar track in the previous frame, or the target dynamic fusion track in the previous frame being not obtained via the camera track in the previous frame.

The vehicle control method may further include: obtaining a fusion track in the specific frame, based on at least one of the camera track in the specific frame, or the radar track in the specific frame; and obtaining the target dynamic fusion track, based on at least one of a LiDAR track in the specific frame or the fusion track.

Deleting the target dynamic fusion track may include: deleting the target dynamic fusion track, based on the target dynamic fusion track being obtained only via the radar track in the specific time, and based on at least one of: a position of the target dynamic fusion track being included in a specified area with respect to the vehicle, the target dynamic fusion track being obtained based on only the fusion track obtained in the specific frame, the target dynamic fusion track in the previous frame, corresponding to the target dynamic fusion track, being obtained via the LiDAR and corresponding to the target object, or a second dynamic fusion track different from the target dynamic fusion track being obtained via the LiDAR track in the specific frame.

Deleting the target dynamic fusion track may include: deleting the target dynamic fusion track, based on the target dynamic fusion track being obtained only via the radar track in the specific frame, and based on at least one of: a position of the target dynamic fusion track being included in a specified area with respect to the vehicle, the target dynamic fusion track being obtained based on only the fusion track obtained in the specific frame, the fusion track in the previous frame being obtained via the camera track, a second fusion track different from the fusion track in the specific frame being obtained via the camera track, a third fusion track different from the fusion track being obtained via the camera track in the specific frame, or a second dynamic fusion track different from the target dynamic fusion track being obtained via the camera track in the specific frame.

The vehicle control method may further include: determining, in a lane in which the vehicle is located, a point, at which a difference between a longitudinal position of the vehicle and a longitudinal position of the point is less than a specified distance, to be included in the specified area.

The vehicle control method may further include: classifying the target object corresponding to the deleted target dynamic fusion track as an object incapable of being in the movement state.

Each of the plurality of dynamic fusion tracks may correspond to at least one of a pedestrian, an automobile, a two-wheeled vehicle, or a bicycle.

Obtaining the plurality of dynamic fusion tracks may include: obtaining the plurality of dynamic fusion tracks, via at least one of the LiDAR, the camera for capturing a front of the vehicle, the radar, a near vehicle detector (NVD) camera for capturing a rear of the vehicle, or a rear side view (PSIR) camera for capturing a rear corner of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a vehicle control apparatus;

FIG. 2 illustrates a situation in which misrecognition of a target object is able to occur, in a vehicle control apparatus or a vehicle control method;

FIG. 3 illustrates an example of object recognition of a vehicle control apparatus, which is associated with the vehicle control apparatus or a vehicle control method;

FIG. 4 illustrates an example of flow of an operation of a vehicle control apparatus for deleting a dynamic fusion track, if the dynamic fusion track is obtained based on only a LiDAR track, in the vehicle control apparatus or a vehicle control method;

FIG. 5 illustrates an example of flow of an operation of a vehicle control apparatus for deleting a dynamic fusion track, if the dynamic fusion track is obtained based on only a radar track, in the vehicle control apparatus or a vehicle control method;

FIG. 6 illustrates an example of flow of an operation of a vehicle control apparatus for deleting a dynamic fusion track, if the dynamic fusion track is obtained based on only a radar track, in the vehicle control apparatus or a vehicle control method;

FIG. 7 illustrates an example of flow of an operation of a vehicle control apparatus for deleting a target dynamic fusion track, in the vehicle control apparatus or a vehicle control method;

FIG. 8 illustrates an example of a screen obtained based on a dynamic fusion track which remains without deletion, in a vehicle control apparatus or a vehicle control method; and

FIG. 9 illustrates a computing system associated with a vehicle control apparatus or a vehicle control method.

### DETAILED DESCRIPTION

Hereinafter, some example embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of example embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The terms “ . . . device”. “ . . . unit”, “ . . . thing”, and “ . . . body’ used hereinafter may refer to at least one shape structure or refer to a unit for processing a function.

Furthermore, the expression “greater than” or “less than” may be used to determine whether a specific condition is satisfied or fulfilled, but is only to represent an example and does not exclude the description “greater than or equal to” or “less than or equal to”. A condition described as being “greater than or equal to” may be replaced with a condition described as being “greater than”, a condition describing as being “less than or equal to” may be replaced with a condition described as being “less than”, and a condition described as being “greater than or equal to and less than” may be replaced with “greater than and less than or equal to”. Furthermore, hereinafter, the expression “A to B” refers to at least one of elements (including B) from A to B (including A).

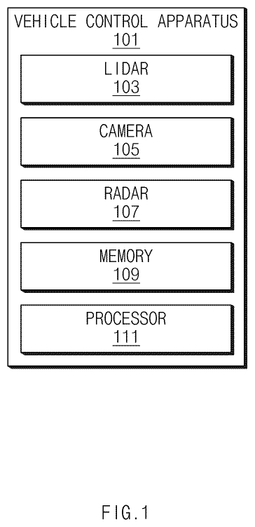

Hereinafter, one or more example embodiments of the present disclosure will be described in detail with reference to FIGS. 1 to 9.

FIG. 1 is a block diagram illustrating a vehicle control apparatus.

Referring to FIG. 1, a vehicle control apparatus 101 may be implemented in a vehicle. In this case, the vehicle control apparatus 101 included in the vehicle may be integrally configured with control units in the vehicle or may be implemented as a separate device to be connected with the control units of the vehicle by a separate connection means.

Referring to FIG. 1, the vehicle control apparatus 101 may include light detection and ranging (LiDAR) 103, a camera 105, radio detection and ranging (radar) 107, a memory 109, and a processor 111.

The processor 111 of the vehicle control apparatus 101 may obtain information about an external object located outside a host vehicle, based on at least one of the LiDAR 103, the camera 105, the radar 107, a near vehicle detector (NVD) camera, or a rear side view (RSIR) camera, or any combination thereof. The accuracy of the information about the external object obtained by means of the plurality of sensors (e.g., at least one of the LiDAR 103, the camera 105, the radar 107, the NVD camera, or the RSIR camera, or any combination thereof) may be greater than the accuracy of information about an external object obtained by means of a single sensor (e.g., the LiDAR 103, the camera 105, the radar 107, the NVD camera, or the RSIR camera).

A track may refer to an act of tracking an object and/or an object thus being tracked. A track may associate consecutive observations (e.g., frames) by a sensor (e.g., a radar, a LiDAR, etc.) to a single target. A track may be, for example, a virtual object or representation that corresponds to a physical object (e.g., a vehicle, a pedestrian, an obstacle, debris, etc.) that is being tracked. A track may be associated with a set of data (e.g., tracking data) or information that represents an object being tracked. For example, a LiDAR track may be data or representation (e.g., tracking data) that corresponds to an object being tracked. There could be more than one track (e.g., a camera track, a LiDAR track, a radar track, etc.) for a single object depending on which sensor and/or instrument is being used to track the object. If a track is determined to be an inaccurate representation of a physical object, the track can be deleted (e.g., removed from a database). The deleted track may be no longer tracked. The dynamic fusion track may indicate a track corresponding to a plurality of external objects classified into objects (e.g., a pedestrian, an automobile, a two-wheeled vehicle, and a bicycle) capable of being in a movement state. The dynamic fusion track may be referred to as a dynamic object fusion (DOF) track.

For example, the processor 111 of the vehicle control apparatus 101 may obtain LiDAR points indicating an external object of the host vehicle by means of the LiDAR 103. The processor 111 of the vehicle control apparatus 101 may obtain a LiDAR track which includes LiDAR points and corresponds to the external object.

For example, the processor 111 of the vehicle control apparatus 101 may obtain an image indicating the external object by means of the camera 105. The processor 111 of the vehicle control apparatus 101 may obtain a camera track corresponding to the external object based on the obtained image.

For example, the processor 111 of the vehicle control apparatus 101 may obtain radar points indicating the external object by means of the radar 107. The processor 111 of the vehicle control apparatus 101 may obtain a radar track corresponding to the external object based on the obtained radar points.

For example, the processor 111 of the vehicle control apparatus 101 may obtain a fusion track, based on the camera track or the radar track, or any combination thereof. However, if the camera track is not obtained, the processor 111 of the vehicle control apparatus 101 may obtain a fusion track based on only the radar track. If the radar track is not obtained, the processor 111 of the vehicle control apparatus 101 may obtain a fusion track based on only the camera track.

For example, the processor 111 of the vehicle control apparatus 101 may obtain a dynamic fusion track based on at least one of the fusion track or the LiDAR track, or any combination thereof. However, if the fusion track is not obtained, the processor 111 of the vehicle control apparatus 101 may obtain a dynamic fusion track based on only LiDAR track. If the LiDAR track is not obtained, the processor 111 of the vehicle control apparatus 101 may obtain a dynamic fusion track based on only the fusion track.

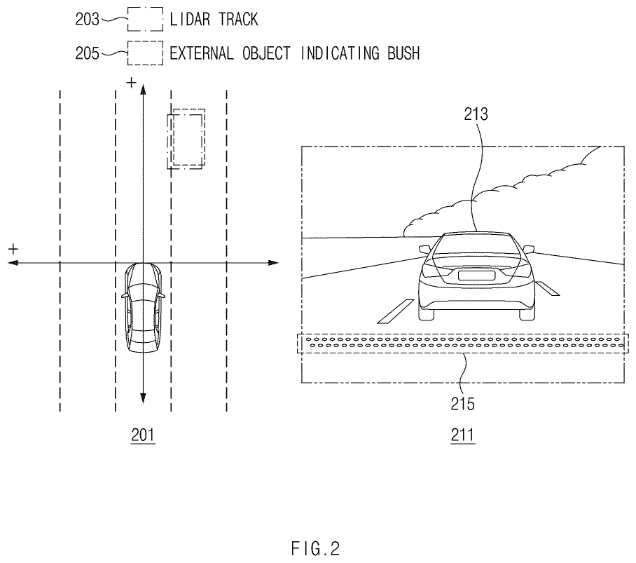

The processor 111 of the vehicle control apparatus 101 may obtain a dynamic fusion track corresponding to the external object which is an object incapable of being in the movement state due to the limit of the sensor, thus recognizing the external object as an object capable of being in the movement state. If the dynamic fusion track corresponding to the external object which is the object incapable of being in the movement state is obtained, the processor 111 of the vehicle control apparatus 101 may delete the dynamic fusion track. Furthermore, the processor 111 of the vehicle control apparatus 101 may control the host vehicle, based on at least one dynamic fusion track which remains without deletion among the plurality of dynamic fusion tracks. Contents of the limit of the sensor will be described below with reference to FIG. 2.

The processor 111 of the vehicle control apparatus 101 may obtain a plurality of dynamic fusion tracks in a specific frame (e.g., a frame of data obtained through a sensor such as a camera, a LiDAR, a radar, etc.), which correspond to the plurality of external objects classified as objects capable of being in the movement state, based on at least one of the LiDAR 103, the camera 105, the radar 107, the NVD camera, or the RSIR camera, or any combination thereof. If obtaining a target dynamic fusion track in the specific frame, which corresponds to a target object among the plurality of external objects, based on only the LiDAR 103, the processor 111 of the vehicle control apparatus 101 may delete the target dynamic fusion track among the plurality of dynamic fusion tracks, based on at least one of whether an error occurs in the radar 107 and the camera 105 in the specified frame, a type in which the target dynamic fusion track is classified, a camera track in a previous frame included within a specified time from the specific frame, or a radar track in the previous frame, or any combination thereof. Furthermore, the processor 111 of the vehicle control apparatus 101 may control the host vehicle, based on at least one dynamic fusion track in the specific frame, which remains without deletion, among the plurality of dynamic fusion tracks. The target object corresponding to the deleted target dynamic fusion track may be classified as an object incapable of being in the movement state, without being classified as an object capable of being in the movement state. Therefore, the processor 111 of the vehicle control apparatus 101 may control the host vehicle, based on the at least one dynamic fusion track which remains without deletion.

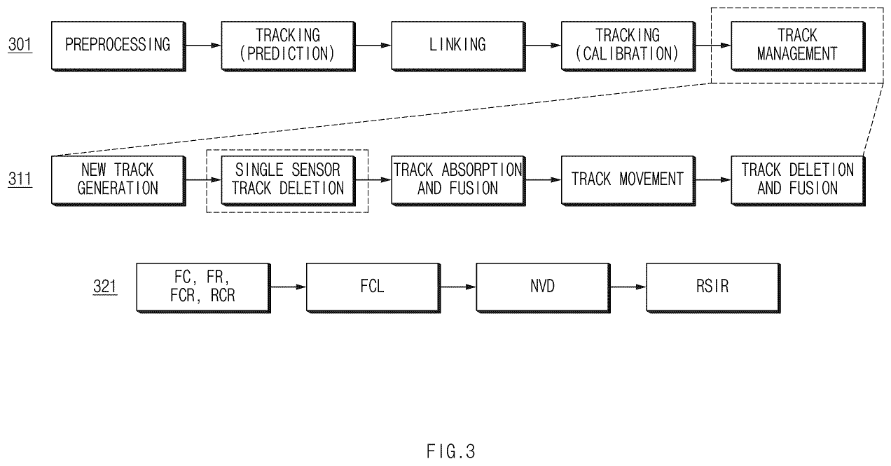

The vehicle control apparatus 101 may further include the near vehicle detector (NVD) camera different from a camera for capturing the front of the host vehicle to capture the rear of the host vehicle, and the rear side view (RSIR) camera different from the front of the host vehicle to capture a rear corner of the host vehicle. Contents of the NVD camera and the RSIR camera will be described below with reference to FIG. 3.

FIG. 2 illustrates a situation in which misrecognition of a target object is able to occur, in a vehicle control apparatus or a vehicle control method.

Referring to FIG. 2, a first situation 201 may indicate an example of a case in which a dynamic fusion track is obtained based on only a LiDAR track 203. In the first situation 201, the LiDAR track 203 may correspond to an external object 205 indicating a bush. A second situation 211 may indicate an example of a case in which a dynamic fusion track is obtained based on only a radar track. The radar track may correspond to a first external object 213 and a second external object 215.

The accuracy of information about an external object obtained by LiDAR of the vehicle control apparatus may be smaller than the accuracy of information about the external object obtained by a camera and the accuracy of information about the external object obtained by radar. Therefore, the processor of the vehicle control apparatus may classify a dynamic fusion track obtained based on the LiDAR track 203 corresponding to an external object (e.g., a bush) which is an object incapable of being in a movement state as an automobile or being unknown. Because the processor of the vehicle control apparatus classifies the external object, which is the object incapable of being in the movement state, as the automobile or being unknown, it may incorrectly brake a host vehicle.

Particularly, the accuracy of an external object with a small radar cross section (RCS) among external objects which are objects incapable of being in the movement state, that is, an external object identified by means of a front camera, a front radar, a front corner radar, or a rear corner radar, or NVD may be greater than the accuracy of the external object obtained by means of LiDAR.

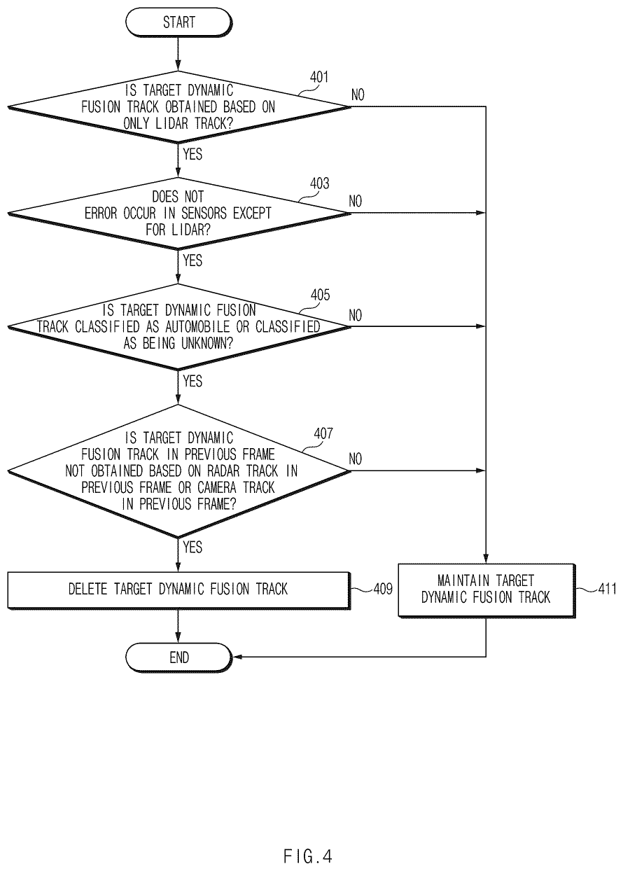

Therefore, the processor of the vehicle control apparatus may identify whether a dynamic fusion track for supplementing a classification performance problem of the LiDAR is obtained based on any track and may delete a dynamic fusion track in which a probability that the dynamic fusion track will be misrecognized is greater than or equal to a reference value. To determine whether the probability that the dynamic fusion track will be misrecognized is greater than or equal to the reference value, the processor of the vehicle control apparatus may determine whether a specific condition is satisfied. Contents for supplementing the classification performance problem of the LiDAR will be described below with reference to FIG. 4.

The second situation 211 may indicate the example of the case in which the dynamic fusion track is obtained based on only the radar track. In the second situation 211, the radar track may correspond to the first external object 213 and the second external object 215.

The second external object 215 (e.g., a covering plate, a drainage ditch, or a pier joint) which is located on the road ground and has an RCS greater than the reference value may overlap the first external object 213 (e.g., a preceding vehicle). It may be difficult for the processor of the vehicle control apparatus to distinguish between the first external object 213 and the second external object 215 based on the radar. Although a difference in longitudinal position between the first external object 213 and the second external object 215 occurs as the first external object 213 changes in position, the processor of the vehicle control apparatus may identify the first external object 213 and the second external object 215 as one radar track and may identify a dynamic fusion track based on the one radar track. Thus, the accuracy of the longitudinal position of the dynamic fusion track identified based on only the radar track corresponding to the plurality of external objects may be less than the reference value.

Because the processor of the vehicle control apparatus recognizes the longitudinal position of the dynamic fusion track such that the accuracy of the longitudinal position of the dynamic fusion track is less than the reference value, it may identify a risk of collision of the host vehicle to be greater than a risk of actual collision.

Therefore, the processor of the vehicle control apparatus may delete a dynamic fusion track in which a probability that the dynamic fusion track will be misrecognized is greater than or equal to the reference value to supplement the object classification performance of the radar. To determine whether the probability that the dynamic fusion track will be misrecognized is greater than or equal to the reference value, the processor of the vehicle control apparatus may determine whether a specific condition is satisfied. Contents for supplementing the object classification performance of the radar will be described below with reference to FIG. 4.

FIG. 3 illustrates an example of object recognition of a vehicle control apparatus, which is associated with the vehicle control apparatus or a vehicle control method.

Referring to FIG. 3, the vehicle control apparatus may include a preprocessing device, a tracking device for performing prediction and calibration, a linking device, and a track management device.

Hereinafter, a sensor may indicate LiDAR 103, a camera 105, radar 107, a near vehicle detector (NVD) camera, or a rear side view (RSIR) camera.

The vehicle control apparatus may perform a process 301 of identifying an external object around a host vehicle to identify a dynamic fusion track. The process 301 of identifying the external object may include a preprocessing process using the preprocessing device, a prediction process using the tracking device, a linking process using the linking device, a calibration process using the tracking device, and a track management process using the track management device. The track management process 311 may include a new track generation process, a single sensor track deletion process, a track absorption and fusion process, a track movement process, and a track deletion and fusion process. A sensor set 321 for generating a dynamic fusion track may include at least one of a corner radar (CR) including a front corner radar (FCR) and a rear corner radar (RCR), a front camera (FC), a front radar (FR), front corner LiDAR (FCL), near vehicle detection (NVD), or rear side view (RSIR), or any combination thereof.

A processor of the vehicle control apparatus may obtain a fusion track based on the FC, the FR, the FCR, and the RCR. The processor of the vehicle control apparatus may obtain a LiDAR track based on the FCL. The processor of the vehicle control apparatus may obtain an NVD track based on the NVD. The NVD may include an NVD camera for capturing the rear of the host vehicle. The NVD may indicate a sensor for identifying an object close to the host vehicle. The RSIR may include an RSIR camera for capturing the rear corner of the host vehicle.

The processor of the vehicle control apparatus may obtain a plurality of dynamic fusion tracks, based on at least one of the LiDAR, the camera, the radar, the NVD camera, or the RSIR camera, or any combination thereof.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the used conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

The fusion track may be referred to as a sensor fusion star (SF*) track, but the present disclosure is not limited thereto. The dynamic fusion track may be referred to as a dynamic object fusion (DOF) track, but the present disclosure is not limited thereto.

An autonomous driving device or a driving assistance device may perform autonomous driving or driving through a surrounding environment recognition process, a determination process, and a control process. The vehicle control apparatus included in the host vehicle may perform the process 301 of identifying the external object around the host vehicle. The process 301 of identifying the external object around the host vehicle, which is performed by the vehicle control apparatus, may include a preprocessing process using the preprocessing device, a tracking prediction process using the tracking device for performing prediction, a linking process using the linking device, a tracking calibration process using the tracking device for performing calibration, and a track management process using the tracking management device. However, the present disclosure is not limited to the vehicle including the autonomous driving device or the driving assistance device.

The vehicle control apparatus may perform a validity check for tracks identified by the respective sensors to select a track suitable for fusion, by means of the preprocessing device in the preprocessing process. The vehicle control apparatus may identify whether the tracks identified by the respective sensors indicate the same object, by means of the linking device in the linking process. The vehicle control apparatus may assign an identifier (ID) to the dynamic fusion track, may process the dynamic fusion track, and may determine whether to delete the dynamic fusion track, by means of the track management device.

In the track management process 311, the track management device may generate, maintain, and delete a dynamic fusion track identified by at least one sensor. If the dynamic fusion track obtained by a single number of sensors by means of the track management device satisfies a specific condition, the vehicle control apparatus may perform an operation of deleting the dynamic fusion track, an operation of absorbing and fusing a plurality of dynamic fusion tracks, and an operation of deleting and fusing the dynamic fusion track.

For example, the vehicle control apparatus may assign an ID to the dynamic fusion track in the new track generation operation using the track management device, may update age information, and may maintain the age information.

For example, the vehicle control apparatus may perform fusion for identifying a large vehicle around the host vehicle as one track, in the track absorption and fusion operation using the track management device.

For example, the vehicle control apparatus may move a track to prevent an intrusion into a host vehicle's lane in a direction next to the host vehicle's lane, in the track movement operation using the track management device.

For example, the vehicle control apparatus may delete a dynamic fusion track with low reliability between two different dynamic fusion tracks in the track deletion and fusion operation using the track management device.

For example, the vehicle control apparatus may include a first module (e.g., IsValidFCLidarOnlyTrack), a second module (e.g., IsValidSFOnlyTrack), a third module (e.g., IsValidNVDOnlyTrack), a fourth module (e.g., IsValid RIR OnlyTrack), a fifth module (e.g., IsValidRSIROnlyTrack), a sixth module (e.g., IsValidFCtOnlyTrack), and a seventh module (e.g., IsValidFROnlyTrack), which are used in the single sensor track deletion operation using the track management device.

The vehicle control apparatus may identify tracks (e.g., a fusion track, a LiDAR track, an NVD track, and an RSIR track) for identifying a dynamic fusion track by means of at least one sensor (e.g., the FC, the FR, the FCR, the RCR, the FCL, the NVD camera, or the RSIR camera) included in the sensor set 321 for generating the dynamic fusion track.

FIG. 4 illustrates an example of flow of an operation of a vehicle control apparatus for deleting a dynamic fusion track, if the dynamic fusion track is obtained based on only a LiDAR track, in the vehicle control apparatus or a vehicle control method.

Hereinafter, it is assumed that a vehicle control apparatus 101 of FIG. 1 performs a process of FIG. 4. Furthermore, in a description of FIG. 4, an operation described as being performed by a processor of a vehicle control apparatus may be understood as being controlled by a processor 111 of the vehicle control apparatus 101.

Referring to FIG. 4, in first operation 401, the processor of the vehicle control apparatus may determine whether a target dynamic fusion track is obtained based on only a LiDAR track. If the target dynamic fusion track is obtained based on only the LiDAR track, the processor of the vehicle control apparatus may perform second operation 403. If the target dynamic fusion track is obtained based on a track except for the LiDAR track, the processor of the vehicle control apparatus may perform third operation 411.

In other words, the processor of the vehicle control apparatus may determine whether the target dynamic fusion track in a specific frame is obtained, based on only the LiDAR track in the specific frame, which is obtained by means of LiDAR and corresponds to a target object.

In second operation 403, the processor of the vehicle control apparatus may determine whether an error does not occur in sensors (e.g., radar, a camera, an NVD camera, and an RSIR camera) except for the LiDAR. If the error does not occur in the sensors except for the LiDAR track, the processor of the vehicle control apparatus may perform fourth operation 405. If the error occurs in the sensors except for the LiDAR track, the processor of the vehicle control apparatus may perform third operation 411.

In other words, the processor of the vehicle control apparatus may determine whether an error does not occur in all the radar, the camera, the NVD camera, and the RSIR camera. If the error occurs in the other sensors except for the LiDAR and if a dynamic fusion track is deleted, this is because the vehicle control apparatus is unable to identify an object capable of being in a movement state.

In fourth operation 405, the processor of the vehicle control apparatus may determine whether the target dynamic fusion track is classified as an automobile or is classified as being unknown. If the target dynamic fusion track is classified as the automobile or is classified as being unknown, the processor of the vehicle control apparatus may perform fifth operation 407. If the target dynamic fusion track is not classified as the automobile or is not classified as being unknown, the processor of the vehicle control apparatus may perform third operation 411.

In fifth operation 407, the processor of the vehicle control apparatus may determine whether the target dynamic fusion track in a previous frame is not obtained based on a radar track in the previous frame or a camera track in the previous frame. If the target dynamic fusion track in the previous frame is obtained based on the radar track in the previous frame or is obtained based on the camera track in the previous frame, the processor of the vehicle control apparatus may perform sixth operation 409. If the target dynamic fusion track in the previous frame is obtained not based on the radar track in the previous frame or is obtained not based on the camera track in the previous frame or if the target dynamic fusion track in the previous frame is not obtained, the processor of the vehicle control apparatus may perform third operation 411.

The target dynamic fusion track in the previous frame may be obtained in the previous frame and may correspond to a target dynamic fusion track in the specific frame. The previous frame may be included within a specified time (e.g., about 10 seconds) from the specific frame. The radar track in the previous frame may indicate a radar track obtained in the previous frame. The camera track in the previous frame may indicate a camera track obtained in the previous frame. The specified time may be referred to as a turning parameter, but the present disclosure is not limited thereto.

The processor of the vehicle control apparatus may determine whether the target dynamic fusion track in the previous frame is obtained based on the tracks obtained based on the sensors except for the LiDAR in the previous frame. If the target dynamic fusion track in the previous frame is obtained using the tracks (e.g., the camera track, the radar track, the NVD track, and the RSIR track) obtained based on the sensors except for the LiDAR, the processor of the vehicle control apparatus may perform sixth operation 409. If the target dynamic fusion track in the previous frame is obtained not based on the tracks obtained based on the sensors except for the LiDAR in the previous frame or is obtained not based on the camera track in the previous frame or if the target dynamic fusion track in the previous frame is not obtained, the processor of the vehicle control apparatus may perform third operation 411.

This is because a probability that a target object if the target dynamic fusion track in the previous frame, which corresponds to the target dynamic fusion track in the specific frame, is obtained will be an object (e.g., a bush) incapable of being in the movement state is greater than a probability that a target object if the target dynamic fusion track in the previous frame, which corresponds to the target dynamic fusion track in the specific frame, is not obtained will be the object (e.g., the bush) incapable of being in the movement state.

In sixth operation 409, the processor of the vehicle control apparatus may delete the target dynamic fusion track. Furthermore, the processor of the vehicle control apparatus may control the host vehicle, based on at least one dynamic fusion track in the specific frame, which remains without deletion, among a plurality of dynamic fusion tracks in the specific frame, which correspond to a plurality of external objects.

In third operation 411, the processor of the vehicle control apparatus may maintain the target dynamic fusion track. Therefore, the processor of the vehicle control apparatus may control the host vehicle based on the target dynamic fusion track.

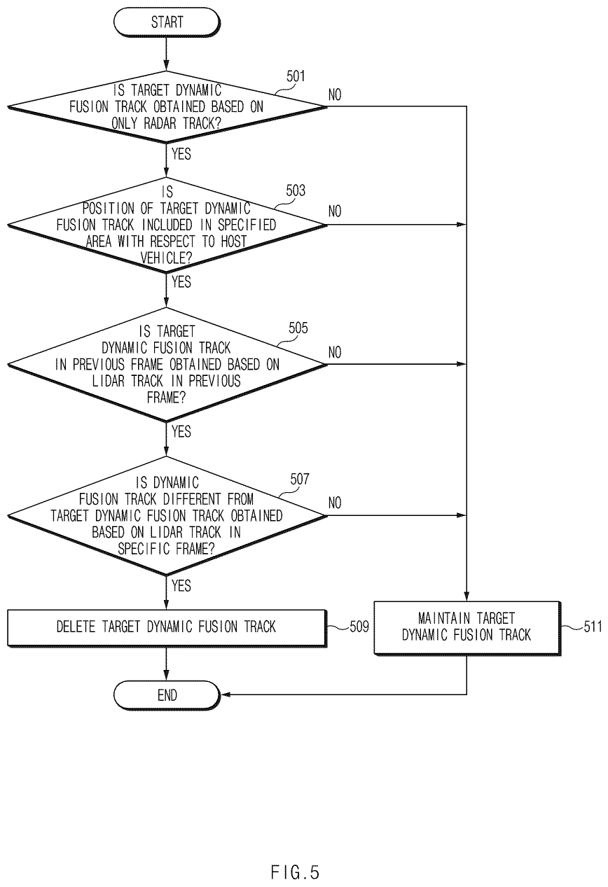

FIG. 5 illustrates an example of flow of an operation of a vehicle control apparatus for deleting a dynamic fusion track, if the dynamic fusion track is obtained based on only a radar track, in the vehicle control apparatus or a vehicle control method.

Hereinafter, it is assumed that a vehicle control apparatus 101 of FIG. 1 performs a process of FIG. 5. Furthermore, in a description of FIG. 5, an operation described as being performed by a processor of a vehicle control apparatus may be understood as being controlled by a processor 111 of the vehicle control apparatus 101.

Referring to FIG. 5, in first operation 501, the processor of the vehicle control apparatus may determine whether a target dynamic fusion track is obtained based on only a radar track. If the target dynamic fusion track is obtained based on only the radar track, the processor of the vehicle control apparatus may perform second operation 503. If the target dynamic fusion track is obtained not based on the radar track, the processor of the vehicle control apparatus may perform third operation 511.

In second operation 503, the processor of the vehicle control apparatus may determine whether the position of the target dynamic fusion track is included in a specified area with respect to a host vehicle. If the position of the target dynamic fusion track is included in the specified area with respect to the host vehicle, the processor of the vehicle control apparatus may perform fourth operation 505. If the position of the target dynamic fusion track is not included in the specified area with respect to the host vehicle, the processor of the vehicle control apparatus may perform third operation 511.

The specified area may include a point, which is included in a lane in which the host vehicle is located, at which a difference between a longitudinal position of the host vehicle and a longitudinal position of the point is less than a specified distance.

In fourth operation 505, the processor of the vehicle control apparatus may determine whether the target dynamic fusion track in a previous frame is obtained based on a LiDAR track in the previous frame. If the target dynamic fusion track in the previous frame is obtained based on the LiDAR track in the previous frame, the processor of the vehicle control apparatus may perform fifth operation 507. If the target dynamic fusion track in the previous frame is obtained not based on the LiDAR track in the previous frame or the target dynamic fusion track in the previous frame is not obtained, the processor of the vehicle control apparatus may perform third operation 511. The previous frame may be included within a specified time (e.g., about 10 seconds) from the specific frame. The specified time may be referred to as a turning parameter, but the present disclosure is not limited thereto.

In fifth operation 507, the processor of the vehicle control apparatus may determine whether a dynamic fusion track different from the target dynamic fusion track is obtained based on a LiDAR track in the specific frame. If the dynamic fusion track different from the target dynamic fusion track is obtained based on the LiDAR track in the specific frame, the processor of the vehicle control apparatus may perform sixth operation 509. If the different dynamic fusion track is obtained not based on the LiDAR track in the specific frame or the different dynamic fusion track is not obtained, the processor of the vehicle control apparatus may perform third operation 511.

In sixth operation 509, the processor of the vehicle control apparatus may delete the target dynamic fusion track. Furthermore, the processor of the vehicle control apparatus may control the host vehicle, based on at least one dynamic fusion track in the specific frame, which remains without deletion, among a plurality of dynamic fusion tracks in the specific frame, which correspond to a plurality of external objects.

In third operation 511, the processor of the vehicle control apparatus may maintain the target dynamic fusion track. Therefore, the processor of the vehicle control apparatus may control the host vehicle based on the target dynamic fusion track.

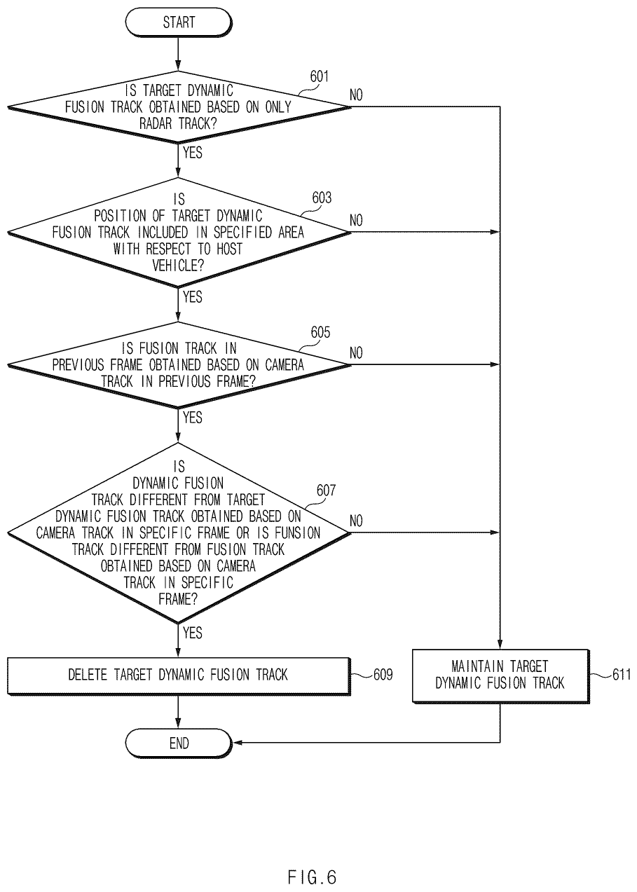

FIG. 6 illustrates an example of flow of an operation of a vehicle control apparatus for deleting a dynamic fusion track, if the dynamic fusion track is obtained based on only a radar track, in the vehicle control apparatus or a vehicle control method.

Hereinafter, it is assumed that a vehicle control apparatus 101 of FIG. 1 performs a process of FIG. 6. Furthermore, in a description of FIG. 6, an operation described as being performed by a processor of a vehicle control apparatus may be understood as being controlled by a processor 111 of the vehicle control apparatus 101.

Referring to FIG. 6, in first operation 601, the processor of the vehicle control apparatus may determine whether a target dynamic fusion track is obtained based on only a radar track. If the target dynamic fusion track is obtained based on only the radar track, the processor of the vehicle control apparatus may perform second operation 603. If the target dynamic fusion track is obtained not based on the radar track, the processor of the vehicle control apparatus may perform third operation 611.

In second operation 603, the processor of the vehicle control apparatus may determine whether the position of the target dynamic fusion track is included in a specified area with respect to a host vehicle. If the position of the target dynamic fusion track is included in the specified area with respect to the host vehicle, the processor of the vehicle control apparatus may perform fourth operation 605. If the position of the target dynamic fusion track is not included in the specified area with respect to the host vehicle, the processor of the vehicle control apparatus may perform third operation 611.

The specified area may include a point, which is included in a lane in which the host vehicle is located, at which a difference between a longitudinal position of the host vehicle and a longitudinal position of the point is less than a specified distance.

In fourth operation 605, the processor of the vehicle control apparatus may determine whether a fusion track in a previous frame is obtained based on a camera track in the previous frame. If the fusion track in the previous frame is obtained based on the camera track in the previous frame, the processor of the vehicle control apparatus may perform fifth operation 607. If the fusion track in the previous frame is obtained not based on the camera track in the previous frame or the fusion track in the previous frame is not obtained, the processor of the vehicle control apparatus may perform third operation 611. The previous frame may be included within a specified time (e.g., about 10 seconds) from the specific frame. The specified time may be referred to as a turning parameter, but the present disclosure is not limited thereto.

In fifth operation 607, the processor of the vehicle control apparatus may determine whether a dynamic fusion track different from a target dynamic fusion track is obtained based on a camera track in a specific frame or a fusion track different from the fusion track is obtained based on the camera track in the specific frame. If the dynamic fusion track different from the target dynamic fusion track is obtained based on the camera track in the specific frame and the fusion track different from the fusion track is obtained based on the camera track in the specific frame, the processor of the vehicle control apparatus may perform sixth operation 609. If determining that the different dynamic fusion track is obtained not based on the camera track in the specific frame and the different fusion track is not obtained and determining that the fusion track different from the fusion track is obtained not based on the camera track in the specific frame or that the different fusion track is not obtained, the processor of the vehicle control apparatus may perform third operation 611.

In sixth operation 609, the processor of the vehicle control apparatus may delete the target dynamic fusion track. Furthermore, the processor of the vehicle control apparatus may control the host vehicle, based on at least one dynamic fusion track in the specific frame, which remains without deletion, among a plurality of dynamic fusion tracks in the specific frame, which correspond to a plurality of external objects.

In third operation 611, the processor of the vehicle control apparatus may maintain the target dynamic fusion track. Therefore, the processor of the vehicle control apparatus may control the host vehicle based on the target dynamic fusion track.

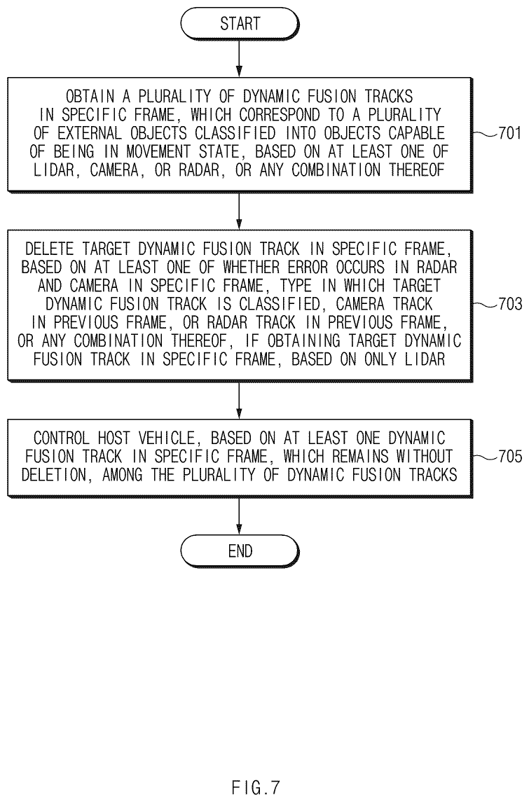

FIG. 7 illustrates an example of flow of an operation of a vehicle control apparatus for deleting a target dynamic fusion track, in the vehicle control apparatus or a vehicle control method.

Hereinafter, it is assumed that a vehicle control apparatus 101 of FIG. 1 performs a process of FIG. 7. Furthermore, in a description of FIG. 7, an operation described as being performed by a processor of a vehicle control apparatus may be understood as being controlled by a processor 111 of the vehicle control apparatus 101.

Referring to FIG. 7, in first operation 701, the processor of the vehicle control apparatus may obtain a plurality of dynamic fusion tracks in a specific frame, which correspond to a plurality of external objects classified into objects capable of being in a movement state, based on at least one of LiDAR, a camera, or radar, or any combination thereof.

In second operation 703, the processor of the vehicle control apparatus may delete a target dynamic fusion track in a specific frame, based on at least one of whether an error occurs in the radar and the camera in the specific frame, a type in which the target dynamic fusion track is classified, a camera track in a previous frame, or a radar track in the previous frame, or any combination thereof, if obtaining the target dynamic fusion track in the specific frame, based on only LiDAR.

If obtaining the target dynamic fusion track in the specific frame, which corresponds to a target object among the plurality of external objects, based on only the LiDAR, the processor of the vehicle control apparatus may delete the target dynamic fusion track, based on identifying at least one of that the error does not occur in both the radar and the camera, that the target dynamic fusion track is classified as an automobile, that the target dynamic fusion track is classified as being unknown, that a target dynamic fusion track corresponding to the target dynamic fusion track and obtained in the previous frame is not obtained based on the radar track in the previous frame, or that the target dynamic fusion track in the previous frame is not obtained based on the camera track in the previous frame, or any combination thereof.

In third operation 705, the processor of the vehicle control apparatus may control the host vehicle, based on at least one dynamic fusion track in the specific frame, which remains without deletion, among the plurality of dynamic fusion tracks.

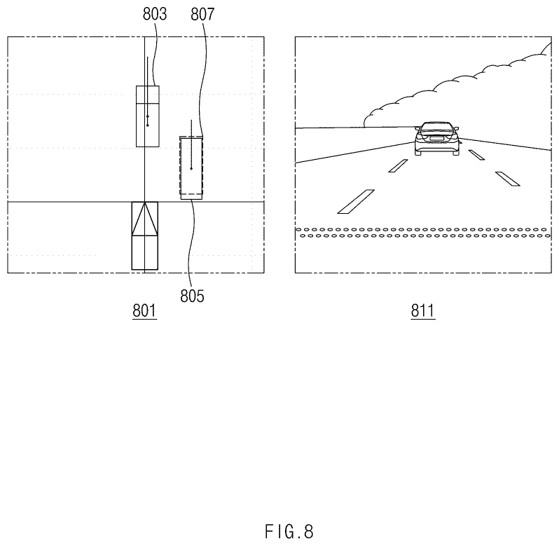

FIG. 8 illustrates an example of a screen obtained based on a dynamic fusion track which remains without deletion, in a vehicle control apparatus or a vehicle control method.

Referring to FIG. 8, a processor of the vehicle control apparatus may obtain a screen 801 indicating a target dynamic fusion track corresponding to a target object. An image 811 may include a plurality of external objects including the target object.

An autonomous driving device (e.g., a vehicle control apparatus for providing a highway driving pilot (HDP) function) or a driving assistance device needs to obtain information about an external object located in front of a host vehicle.

Referring to the image 811, the target object which is a preceding vehicle may pass through a steel structure in the ground.

The vehicle control apparatus may obtain the screen 801 by means of logic for deleting a target dynamic fusion track.

Based on the screen 801, the processor of the vehicle control apparatus may obtain a first fusion track 803 obtained based on only a radar track and a second fusion track 805. The processor of the vehicle control apparatus may obtain a dynamic fusion track 807 corresponding to an external object corresponding to the second fusion track 805.

If a target dynamic fusion track in a specific frame, which is obtained based on the first fusion track 803, is obtained based on only the radar track, the position of the target dynamic fusion track is included in a specified area (e.g., an area including a point, which is included in a lane in which a host vehicle is located, at which a difference between a longitudinal position of the host vehicle and a longitudinal position of the point is less than about 5 m), a target dynamic fusion track in a previous frame is obtained based on a camera track in the previous frame included within a specified time (e.g., about 10 seconds) from the specific frame, a dynamic fusion track (e.g., the dynamic fusion track 807) different from the target dynamic fusion track is obtained based on a camera track in the specific frame, or a fusion track (e.g., the second fusion track 805) different from the first fusion track 803 is obtained based on the camera track in the specific frame, the processor of the vehicle control apparatus may delete the target dynamic fusion track in the specific frame. Therefore, although the preceding vehicle passes through the steel structure in the ground, a dynamic fusion track may not be newly generated. The specified time may be referred to as a turning parameter, but the present disclosure is not limited thereto.

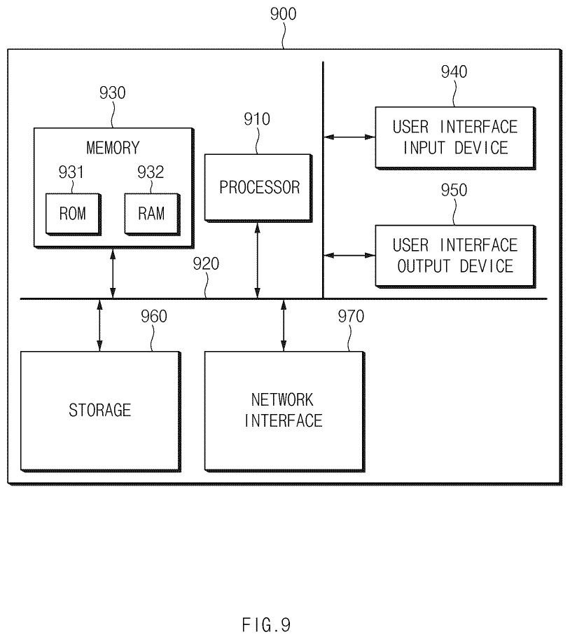

FIG. 9 illustrates a computing system associated with a vehicle control apparatus or a vehicle control method.

Referring to FIG. 9, a computing system 900 may include at least one processor 920, a memory 930, a user interface input device 940, a user interface output device 950, storage 960, and a network interface 970, which are connected with each other via a bus 910.

The processor 910 may be a central processing unit (CPU) or a semiconductor device that processes instructions stored in the memory 930 and/or the storage 960. The memory 930 and the storage 960 may include various types of volatile or non-volatile storage media. For example, the memory 930 may include a read only memory (ROM) 931 and a random-access memory (RAM) 932.

Accordingly, the operations of the method or algorithm described in connection with the one or more example embodiments disclosed in the specification may be directly implemented with a hardware module, a software module, or a combination of the hardware module and the software module, which is executed by the processor 910. The software module may reside on a storage medium (that is, the memory 930 and/or the storage 960) such as a RAM, a flash memory, a ROM, an EPROM, an EEPROM, a register, a hard disc, a removable disk, and a CD-ROM.

The exemplary storage medium may be coupled to the processor 910. The processor 910 may read out information from the storage medium and may write information in the storage medium. Alternatively, the storage medium may be integrated with the processor 910. The processor and the storage medium may reside in an application specific integrated circuit (ASIC). The ASIC may reside within a user terminal. In another case, the processor and the storage medium may reside in the user terminal as separate components.

According to an aspect of the present disclosure, a vehicle control apparatus may include light detection and ranging (LiDAR), a camera, radio detection and ranging (radar), a memory storing at least one instruction, and a processor that executes the at least one instruction.

According to an embodiment, the processor may be configured to obtain a plurality of dynamic fusion tracks in a specific frame, the plurality of dynamic fusion tracks corresponding to a plurality of external objects classified into objects capable of being in a movement state, based on at least one of the LiDAR, the camera, or the radar, or any combination thereof, if obtaining a target dynamic fusion track in the specific frame, the target dynamic fusion track corresponding to a target object among the plurality of external objects, based on only the LiDAR, delete the target dynamic fusion track among the plurality of dynamic fusion tracks, based on at least one of whether an error occurs in the radar and the camera in the specific frame, a type in which the target dynamic fusion track is classified, a camera track in a previous frame, the camera track being obtained by means of the camera and being included within a specified time from the specific frame, or a radar track in the previous frame, the radar track being obtained by means of the radar, or any combination thereof, and control a host vehicle, based on at least one dynamic fusion track in the specific frame, the at least one dynamic fusion track remaining without deletion among the plurality of dynamic fusion tracks.

According to an embodiment, the processor may be configured to delete the target dynamic fusion track, based on identifying at least one of that the error does not occur in both the radar and the camera, that the target dynamic fusion track is classified as an automobile, that the target dynamic fusion track is classified as being unknown, that a target dynamic fusion track corresponding to the target dynamic fusion track and being obtained in the previous frame is not obtained based on the radar track in the previous frame, or that the target dynamic fusion track in the previous frame is not obtained based on the camera track in the previous frame, or any combination thereof, if obtaining the target dynamic fusion track, based on only a LiDAR track in the specific frame, the LiDAR track being obtained by means of the LiDAR and corresponding to the target object.

According to an embodiment, the processor may be configured to obtain a fusion track in the specific frame, based on at least one of a camera track in the specific frame, the camera track being obtained by means of the camera and corresponding to the target object or a radar track in the specific frame, the radar track being obtained by means of the radar and corresponding to the target object, or any combination thereof, and obtain the target dynamic fusion track, based on at least one of a LiDAR track in the specific frame, the LiDAR track being obtained by means of the LiDAR and corresponding to the target object or the fusion track, or any combination thereof.

According to an embodiment, the processor may be configured to delete the target dynamic fusion track among the plurality of dynamic fusion tracks, based on at least one of that a position of the target dynamic fusion track is included in a specified area with respect to the host vehicle, that the target dynamic fusion track is obtained based on only the fusion track obtained based on the radar track in the specific frame, that a target dynamic fusion track in the previous frame, the target dynamic fusion track corresponding to the target dynamic fusion track, based on a LiDAR track in the previous frame, the LiDAR track being obtained by means of the LiDAR and corresponding to the target object, or that a dynamic fusion track different from the target dynamic fusion track is obtained based on the LiDAR track in the specific frame, the LiDAR track corresponding to the LiDAR track in the previous frame, or any combination thereof, if obtaining the target dynamic fusion track in the specific frame, the target dynamic fusion track corresponding to the target object among the plurality of external objects, based on only the radar track in the specific frame, the radar track corresponding to the radar track.

According to an embodiment, the processor may be configured to delete the target dynamic fusion track among the plurality of dynamic fusion tracks, based on at least one of that the position of the target dynamic fusion track is included in the specified area with respect to the host vehicle, that the target dynamic fusion track is obtained based on only the fusion track obtained based on the radar track in the specific frame, that a fusion track in the previous frame, the fusion track corresponding to the fusion track, is obtained based on the camera track, that a fusion track different from the fusion track in the specific frame is obtained based on the camera track, that a fusion track different from the fusion track is obtained based on the camera track in the specific frame, the camera track corresponding to the camera track, or that a dynamic fusion track different from the target dynamic fusion track is obtained based on the camera track in the specific frame, or any combination thereof, if the target dynamic fusion track corresponding to the target object among the plurality of external objects is obtained based on only the radar track in the specific frame, the radar track corresponding to the radar track.

According to an embodiment, the processor may be configured to identify a point included in a lane in which the host vehicle is located, the point at which a difference between a longitudinal position of the host vehicle and a longitudinal position of the point is less than a specified distance to be included in the specified area.

According to an embodiment, the processor may be configured to classify the target object corresponding to the deleted target dynamic fusion track as an object incapable of being in the movement state without classifying the target object as an object capable of being in the movement state.

According to an embodiment, the plurality of dynamic fusion tracks may include a dynamic fusion track corresponding to at least one of a pedestrian, an automobile, a two-wheeled vehicle, or a bicycle, or any combination thereof.

According to an embodiment, the vehicle control apparatus may further include a near vehicle detector (NVD) camera different from the camera for capturing the front of the host vehicle to capture the rear of the host vehicle and a rear side view (RSIR) camera different from the camera to a rear corner of the host vehicle. The processor may be configured to obtain the plurality of dynamic fusion tracks, based on at least one of the LiDAR, the camera, the radar, the NVD camera, or the RSIR camera, or any combination thereof.

According to an embodiment, the processor may be configured to delete the target dynamic fusion track, based on that the error does not occur in all the radar, the camera, the NVD camera, and the RSIR camera, if obtaining the target dynamic fusion track in the specific frame, based on only the LiDAR.

According to an embodiment, the processor may be configured to obtain an NVD track corresponding to the target object by means of the NVD camera, obtain an RSIR track corresponding to the target object by means of the RSIR camera, obtain a fusion track, based on at least one of a camera track in the specific frame, the camera track being obtained by means of the camera, a radar track in the specific frame, the radar track being obtained by means of the radar, the NVD track in the specific frame, or the RSIR track in the specific frame, or any combination thereof, and obtain the plurality of dynamic fusion tracks, based on at least one of the fusion track or a LiDAR track in the specific frame, the LiDAR track being obtained by means of the LiDAR, or any combination thereof.

According to another aspect of the present disclosure, a vehicle control method may include obtaining a plurality of dynamic fusion tracks in a specific frame, the plurality of dynamic fusion tracks corresponding to a plurality of external objects classified into objects capable of being in a movement state, based on at least one of LiDAR, a camera, or radar, or any combination thereof, if obtaining a target dynamic fusion track in the specific frame, the target dynamic fusion track corresponding to a target object among the plurality of external objects, based on only the LiDAR, deleting the target dynamic fusion track among the plurality of dynamic fusion tracks, based on at least one of whether an error occurs in the radar and the camera in the specific frame, a type in which the target dynamic fusion track is classified, a camera track in a previous frame, the camera track being obtained by means of the camera and being included within a specified time from the specific frame, or a radar track in the previous frame, the radar track being obtained by means of the radar, or any combination thereof, and controlling a host vehicle, based on at least one dynamic fusion track in the specific frame, the at least one dynamic fusion track remaining without deletion among the plurality of dynamic fusion tracks.

According to an embodiment, the deleting of the target dynamic fusion track among the plurality of dynamic fusion tracks, based on the at least one of whether the error occurs in the radar and the camera in the specific frame, the type in which the target dynamic fusion track is classified, the camera track in the previous frame, the camera track being obtained by means of the camera and being included within the specified time from the specific frame, or the radar track in the previous frame, the radar track being obtained by means of the radar, or the any combination thereof, may include deleting the target dynamic fusion track, based on identifying at least one of that the error does not occur in both the radar and the camera, that the target dynamic fusion track is classified as an automobile, that the target dynamic fusion track is classified as being unknown, that a target dynamic fusion track corresponding to the target dynamic fusion track and being obtained in the previous frame is not obtained based on the radar track in the previous frame, or that the target dynamic fusion track in the previous frame is not obtained based on the camera track in the previous frame, or any combination thereof, if obtaining the target dynamic fusion track, based on only a LiDAR track in the specific frame, the LiDAR track being obtained by means of the LiDAR and corresponding to the target object.

According to an embodiment, the vehicle control method may further include obtaining a fusion track in the specific frame, based on at least one of a camera track in the specific frame, the camera track being obtained by means of the camera and corresponding to the target object or a radar track in the specific frame, the radar track being obtained by means of the radar and corresponding to the target object, or any combination thereof, and obtaining the target dynamic fusion track, based on at least one of a LiDAR track in the specific frame, the LiDAR track being obtained by means of the LiDAR and corresponding to the target object or the fusion track, or any combination thereof.

According to an embodiment, the vehicle control method may further include deleting the target dynamic fusion track among the plurality of dynamic fusion tracks, based on at least one of that a position of the target dynamic fusion track is included in a specified area with respect to the host vehicle, that the target dynamic fusion track is obtained based on only the fusion track obtained based on the radar track in the specific frame, that a target dynamic fusion track in the previous frame, the target dynamic fusion track corresponding to the target dynamic fusion track, based on a LiDAR track in the previous frame, the LiDAR track being obtained by means of the LiDAR and corresponding to the target object, or that a dynamic fusion track different from the target dynamic fusion track is obtained based on the LiDAR track in the specific frame, the LiDAR track corresponding to the LiDAR track in the previous frame, or any combination thereof, if obtaining the target dynamic fusion track in the specific frame, the target dynamic fusion track corresponding to the target object among the plurality of external objects, based on only the radar track in the specific frame, the radar track corresponding to the radar track.

According to an embodiment, the vehicle control method may further include deleting the target dynamic fusion track among the plurality of dynamic fusion tracks, based on at least one of that the position of the target dynamic fusion track is included in the specified area with respect to the host vehicle, that the target dynamic fusion track is obtained based on only the fusion track obtained based on the radar track in the specific frame, that a fusion track in the previous frame, the fusion track corresponding to the fusion track, is obtained based on the camera track, that a fusion track different from the fusion track in the specific frame is obtained based on the camera track, that a fusion track different from the fusion track is obtained based on the camera track in the specific frame, the camera track corresponding to the camera track, or a dynamic fusion track different from the target dynamic fusion track is obtained based on the camera track in the specific frame, or any combination thereof, if the target dynamic fusion track corresponding to the target object among the plurality of external objects is obtained based on only the radar track in the specific frame, the radar track corresponding to the radar track.

According to an embodiment, the deleting of the target dynamic fusion track among the plurality of dynamic fusion tracks, based on the at least one of that the position of the target dynamic fusion track is included in the specified area with respect to the host vehicle, that the target dynamic fusion track is obtained based on only the fusion track obtained based on the radar track in the specific frame, that the target dynamic fusion track in the previous frame, the target dynamic fusion track corresponding to the target dynamic fusion track, based on the LiDAR track in the previous frame, the LiDAR track being obtained by means of the LiDAR and corresponding to the target object, or that the dynamic fusion track different from the target dynamic fusion track is obtained based on the LiDAR track in the specific frame, the LiDAR track corresponding to the LiDAR track in the previous frame, or the any combination thereof may include identifying a point included in a lane in which the host vehicle is located, the point at which a difference between a longitudinal position of the host vehicle and a longitudinal position of the point is less than a specified distance to be included in the specified area.

According to an embodiment, the vehicle control method may further include classifying the target object corresponding to the deleted target dynamic fusion track as an object incapable of being in the movement state without classifying the target object as an object capable of being in the movement state.

According to an embodiment, the plurality of dynamic fusion tracks may include a dynamic fusion track corresponding to at least one of a pedestrian, an automobile, a two-wheeled vehicle, or a bicycle, or any combination thereof.

According to an embodiment, the vehicle control method may further include obtaining the plurality of dynamic fusion tracks, based on at least one of the LiDAR, the camera for capturing the front of the host vehicle, the radar, a near vehicle detector (NVD) camera for capturing the rear of the host vehicle, or a rear side view (PSIR) camera for capturing a rear corner of the host vehicle, or any combination thereof.

The present technology may provide the vehicle control apparatus for increasing the accuracy of identifying an object capable of being in a movement state and the method thereof.

Furthermore, the present technology may provide the vehicle control apparatus for identifying an object by means of sensors and the method thereof.

Furthermore, the present technology may provide the vehicle control apparatus for decreasing misrecognition or miscontrol, due to the classification performance of LiDAR, and the method thereof.

Furthermore, the present technology may provide the vehicle control apparatus for decreasing misrecognition or miscontrol, due to the object classification performance of radar, and the method thereof.

In addition, various effects ascertained directly or indirectly through the present disclosure may be provided.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, one or more example embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus comprising:
a light detection and ranging device (LiDAR);
a camera;
a radar;
one or more processors; and
memory storing instructions that, when executed by the one or more processors, cause the vehicle control apparatus to:
obtain, via at least one of the LiDAR, the camera, or the radar, a plurality of dynamic fusion tracks in a specific frame, the plurality of dynamic fusion tracks corresponding to a plurality of external objects classified into objects capable of being in a movement state;
delete, among the plurality of dynamic fusion tracks, a target dynamic fusion track corresponding to a target object among the plurality of external objects in the specific frame, based on the target dynamic fusion track being obtained via only the LiDAR among the LiDAR, the camera, and the radar, and further based on at least one of:
whether an error has occurred in the radar and the camera in the specific frame,
an object type of the target dynamic fusion track,
a camera track, in a previous frame, obtained via the camera within a specified time before the specific frame, or
a radar track, in the previous frame, obtained via the radar; and
control a vehicle, based on at least one remaining dynamic fusion track of the plurality of dynamic fusion tracks in the specific frame after the deletion of the target dynamic fusion track.

2. The vehicle control apparatus of claim 1, wherein the instructions, when executed by the one or more processors, cause the vehicle control apparatus to delete the target dynamic fusion track by:
deleting the target dynamic fusion track, based on the target dynamic fusion track being obtained via the LiDAR only, based on only a LiDAR track in the specific frame, and based on at least one of:
the error not having occurred in the radar and the camera in the specific frame,
the object type of the target dynamic fusion track being an automobile,
the object type of the target dynamic fusion track being an unknown type,
the target dynamic fusion track obtained in the previous frame being not obtained via the radar track in the previous frame, or
the target dynamic fusion track in the previous frame being not obtained via the camera track in the previous frame.

3. The vehicle control apparatus of claim 1, wherein the instructions, when executed by the one or more processors, further cause the vehicle control apparatus to:
obtain a fusion track in the specific frame, based on at least one of the camera track in the specific frame, or the radar track in the specific frame; and
obtain the target dynamic fusion track, based on at least one of a LiDAR track in the specific frame or the fusion track.

4. The vehicle control apparatus of claim 3, wherein the instructions, when executed by the one or more processors, cause the vehicle control apparatus to delete the target dynamic fusion track by:
deleting the target dynamic fusion track, based on the target dynamic fusion track being obtained only via the radar track in the specific time, and based on at least one of:
a position of the target dynamic fusion track being included in a specified area with respect to the vehicle,
the target dynamic fusion track being obtained based on only the fusion track obtained in the specific frame,
the target dynamic fusion track in the previous frame, corresponding to the target dynamic fusion track, being obtained via the LiDAR and corresponding to the target object, or
a second dynamic fusion track different from the target dynamic fusion track being obtained via the LiDAR track in the specific frame.

5. The vehicle control apparatus of claim 3, wherein the instructions, when executed by the one or more processors, cause the vehicle control apparatus to delete the target dynamic fusion track by:
deleting the target dynamic fusion track, based on the target dynamic fusion track being obtained only via the radar track in the specific frame, and based on at least one of:
a position of the target dynamic fusion track being included in a specified area with respect to the vehicle,
the target dynamic fusion track being obtained based on only the fusion track obtained in the specific frame,
the fusion track in the previous frame being obtained via the camera track,
a second fusion track different from the fusion track in the specific frame being obtained via the camera track,
a third fusion track different from the fusion track being obtained via the camera track in the specific frame, or
a second dynamic fusion track different from the target dynamic fusion track being obtained via the camera track in the specific frame.

6. The vehicle control apparatus of claim 4, wherein the instructions, when executed by the one or more processors, further cause the vehicle control apparatus to:
determine, in a lane in which the vehicle is located, a point, at which a difference between a longitudinal position of the vehicle and a longitudinal position of the point is less than a specified distance, to be included in the specified area.

7. The vehicle control apparatus of claim 1, wherein the instructions, when executed by the one or more processors, further cause the vehicle control apparatus to:
classify the target object corresponding to the deleted target dynamic fusion track as an object incapable of being in the movement state.

8. The vehicle control apparatus of claim 1, wherein each of the plurality of dynamic fusion tracks correspond to at least one of a pedestrian, an automobile, a two-wheeled vehicle, or a bicycle.

9. The vehicle control apparatus of claim 1, further comprising:
a near vehicle detector (NVD) camera, different from the camera, configured to capture one of a front of the vehicle or a rear of the vehicle; and
a rear side view (RSIR) camera, different from the camera, configured to capture a rear corner of the vehicle,
wherein the instructions, when executed by the one or more processors, further cause the vehicle control apparatus to obtain the plurality of dynamic fusion tracks by:
obtaining the plurality of dynamic fusion tracks via at least one of the LiDAR, the camera, the radar, the NVD camera, or the RSIR camera.

10. The vehicle control apparatus of claim 9, wherein the instructions, when executed by the one or more processors, further cause the vehicle control apparatus to delete the target dynamic fusion track by:
deleting the target dynamic fusion track based on the error not having occurred in the radar, the camera, the NVD camera, and the RSIR camera.

11. The vehicle control apparatus of claim 9, wherein the instructions, when executed by the one or more processors, cause the vehicle control apparatus to obtain the plurality of dynamic fusion tracks by:
obtaining, via the NVD camera, an NVD track corresponding to the target object;
obtaining, via the RSIR camera, an RSIR track corresponding to the target object;
obtaining a fusion track, based on at least one of:
the camera track, in the specific frame, obtained via the camera,
the radar track, in the specific frame, obtained via the radar,
the NVD track in the specific frame, or
the RSIR track in the specific frame; and
obtaining the plurality of dynamic fusion tracks based on at least one of the fusion track or a LiDAR track in the specific frame.

12. A vehicle control method performed by one or more processors, the vehicle control method comprising:
obtaining, via at least one of a light detection and ranging device (LiDAR), a camera, or a radar, a plurality of dynamic fusion tracks in a specific frame, the plurality of dynamic fusion tracks corresponding to a plurality of external objects classified into objects capable of being in a movement state;
deleting, among the plurality of dynamic fusion tracks, a target dynamic fusion track corresponding to a target object among the plurality of external objects in the specific frame, based on the target dynamic fusion track being obtained via only the LiDAR among the LiDAR, the camera, and the radar, and further based on at least one of:
whether an error has occurred in the radar and the camera in the specific frame,
an object type of the target dynamic fusion track,
a camera track, in a previous frame, obtained via the camera within a specified time before the specific frame, or
a radar track, in the previous frame, obtained via the radar; and
controlling a vehicle, based on at least one remaining dynamic fusion track of the plurality of dynamic fusion tracks in the specific frame after the deletion of the target dynamic fusion track.

13. The vehicle control method of claim 12, wherein the deleting of the target dynamic fusion track comprises:
deleting the target dynamic fusion track, based on the target dynamic fusion track being obtained via the LiDAR only, based on only a LiDAR track in the specific frame, and based on at least one of:
the error not having occurred in the radar and the camera in the specific frame,
the object type of the target dynamic fusion track being an automobile,
the object type of the target dynamic fusion track being an unknown type,
the target dynamic fusion track obtained in the previous frame being not obtained via the radar track in the previous frame, or
the target dynamic fusion track in the previous frame being not obtained via the camera track in the previous frame.

14. The vehicle control method of claim 12, further comprising:
obtaining a fusion track in the specific frame, based on at least one of the camera track in the specific frame, or the radar track in the specific frame; and
obtaining the target dynamic fusion track, based on at least one of a LiDAR track in the specific frame or the fusion track.

15. The vehicle control method of claim 14, wherein the deleting of the target dynamic fusion track comprises:
deleting the target dynamic fusion track, based on the target dynamic fusion track being obtained only via the radar track in the specific time, and based on at least one of:
a position of the target dynamic fusion track being included in a specified area with respect to the vehicle,
the target dynamic fusion track being obtained based on only the fusion track obtained in the specific frame,
the target dynamic fusion track in the previous frame, corresponding to the target dynamic fusion track, being obtained via the LiDAR and corresponding to the target object, or
a second dynamic fusion track different from the target dynamic fusion track being obtained via the LiDAR track in the specific frame.

16. The vehicle control method of claim 14, wherein the deleting of the target dynamic fusion track comprises:
deleting the target dynamic fusion track, based on the target dynamic fusion track being obtained only via the radar track in the specific frame, and based on at least one of:
a position of the target dynamic fusion track being included in a specified area with respect to the vehicle,
the target dynamic fusion track being obtained based on only the fusion track obtained in the specific frame,
the fusion track in the previous frame being obtained via the camera track,
a second fusion track different from the fusion track in the specific frame being obtained via the camera track,
a third fusion track different from the fusion track being obtained via the camera track in the specific frame, or
a second dynamic fusion track different from the target dynamic fusion track being obtained via the camera track in the specific frame.

17. The vehicle control method of claim 15, further comprising:
determining, in a lane in which the vehicle is located, a point, at which a difference between a longitudinal position of the vehicle and a longitudinal position of the point is less than a specified distance, to be included in the specified area.

18. The vehicle control method of claim 12, further comprising:
classifying the target object corresponding to the deleted target dynamic fusion track as an object incapable of being in the movement state.

19. The vehicle control method of claim 12, wherein each of the plurality of dynamic fusion tracks correspond to at least one of a pedestrian, an automobile, a two-wheeled vehicle, or a bicycle.

20. The vehicle control method of claim 12, wherein the obtaining of the plurality of dynamic fusion tracks comprise:
obtaining the plurality of dynamic fusion tracks, via at least one of the LiDAR, the camera for capturing a front of the vehicle, the radar, a near vehicle detector (NVD) camera for capturing a rear of the vehicle, or a rear side view (PSIR) camera for capturing a rear corner of the vehicle.
